(19) United States
(12) Patent Application Publication
(10) Pub. No.: US 2011/0259272 A1
(43) Pub. Date: Oct. 27, 2011

(54) Bird Feeder with Bear Deterrent

(76) Inventors: Jeff Traska, Wausau, WI (US); Mark Myshka, Wausau, WI (US)

(21) Appl. No.: 13/094,896

(22) Filed: Apr. 27, 2011

Related U.S. Application Data
(60) Provisional application No. 61/328,399, filed on Apr. 27, 2010.

(51) Int. Cl. A01K 39/01

(52) U.S. Cl. 119/57.9

(57) ABSTRACT

An apparatus and method for feeding birds having a system of ‘no reward” for scavenging animals, such as bears and other non aviary animals.

### CROSS REFERENCE TO RELATED APPLICATIONS

This application claims priority from U.S. provisional application No. 61/328,399 filed 27 Apr. 2010; entitled “Bird Feeder with a Bear Deterrent. The entire contents being hereby included by reference and for which benefit of the priority date is claimed.

### FIELD OF THE INVENTION

The present invention relates to bird feeders. More particularly it is directed toward a method and apparatus for providing a bird feeder having a catch basin which provides no reward to bears and other non-aviary animals, thus deterring such animals.

### BACKGROUND OF THE INVENTION

The general purpose of a bird or aviary feeder is to attract aviary animals or birds for the general enjoyment of the observer. Many times such feeders also attract other non aviary animals, these are typically foraging animals such as; squirrels chipmunks, raccoons and the like, looking for an easy meal, thus interfering with the observations, consuming food designated for the birds, and especially in the case of larger animals such as raccoons and bears, damaging the feeders, posts, and other apparatus provided for the enjoyment of the birds.

Others have provided bird feeder designs providing a general deterrent for smaller animals such as that disclosed in U.S. Pat. No. 5,207,180 to Graham for a squirrel proof shaped bird feeder. This feeder has a shape for defeating smaller animals such as a squirrel from climbing down the outside of the feeder container.

Other bird feeders, such as that disclosed in U.S. Pat. No. 670,867 to Garrison teaches a shield for keeping small animals away from the food source with controls for diverting excess feed from locking mechanisms.

One of the problems associated with prior art methods, stems from the eating habits of the birds themselves. Birds, such as songbirds, typically eat by pecking at a food source which spreads the food and creates edible waste which typically falls to the ground. Other animals including deer, raccoons, squirrels opossums and bears can be seen foraging below bird feeders for food knocked down by the birds. Once the supply of the food is determined, the animal will seek to exploit the source.

It is very difficult to dissuade an animal with the strength and determination of a bear, once the bear is motivated to an activity, from exploiting a food source. A black bear can tear open logs, uproot steel poles, rip open boxes and shelters designed to prevent other smaller animals from destroying them.

Other, smaller, foraging animals rely on agility to reach a food source. There have been many attempts to dissuade such animals from reaching the food source. But again, it would be advantageous to provide a method which does not alert the animal of the actual source.

Others have tried various devices to deter a bear from destroying a feeder by providing an alert such as chimes or alarms should a bear interfere with the feeder. This approach has several, possibly severe, downside risks and disadvantages. Such methods require that the bird feeder be continuously monitored. Then should a bear be detected, the person ‘answering the call’ is placed into a dangerous situation in attempting to drive off a wild bear, coming between it and a potential source of food. There is no guarantee that the bear will not still damage the equipment, the stand, or the person.

### SUMMARY OF THE INVENTION

In accordance with the present invention, there is provided a source of food for birds in such a way as to restrict waste from falling to the ground thus eliminating one of the major behavioral reinforcements to foraging animals such as bears. It has been found that a scent of potential food in the air without the accompanying, and reinforcing, presence of food is insufficient reward to entice a foraging animal to linger. Therefore the bear, for example, will quickly be satisfied that there is no reward and move on.

The present invention is designed to provide a catching device or a catch basin sufficient to catch the waste product food from the birds and prevent the food from falling to the ground. In addition the catch basin can be easily emptied by one person in such a way as to remove residual food from the vicinity of the feeder. The catch basin is designed generally to be above the level which can be reached by a deer, or a bear, or other non aviary large foraging animal. And to have characteristics that the pole and feeder cannot be scaled by other foraging animals such as a squirrel which would otherwise claim the food.

It is an advantage of the present invention to create a feeder having a deterrent for foraging animals which can be left substantially unattended.

It is a further advantage of the present invention to provide a food source for birds which provides no reward for foraging animals.

It is a further advantage of the present invention to allow the hanging of a combination of several popular food sources such as seeds, suet, fruit, and the like.

It is a further advantage of the present invention to create a method for cleaning the feeder which does not leave sources of food.

It is a further advantage of the present invention to create a feeder which can be cleaned in just a few minutes.

The foregoing has outlined rather broadly the features and technical advantages of this invention so that those skilled in the art may better understand the detailed description that follows.

Those skilled in the art will appreciate that they may readily use the conception and the specific embodiments disclosed as a basis for modifying or designing other structures for carrying out the same purposes of the present invention. Those skilled in the art will also realize that such equivalent constructions do not depart from the spirit and scope of the invention in its broadest form.

### BRIEF DESCRIPTION OF THE DRAWINGS

A complete understanding of the present invention may be obtained by reference to the accompanying drawings, when considered in conjunction with the subsequent, detailed description, in which:

FIG. 1 shows a perspective view of a bear approaching one embodiment of the apparatus (a) and losing interest and leaving (b) the apparatus;

FIG. 2 shows a perspective view of details of the embodiment of FIG. 1;

FIG. 3 shows a perspective view of a person emptying the contents of one factet of the embodiment of FIG. 1;

FIGS. 4 A and B show a perspective view of trigger assembly in the set position and release position respectively.

### DETAILED DESCRIPTION

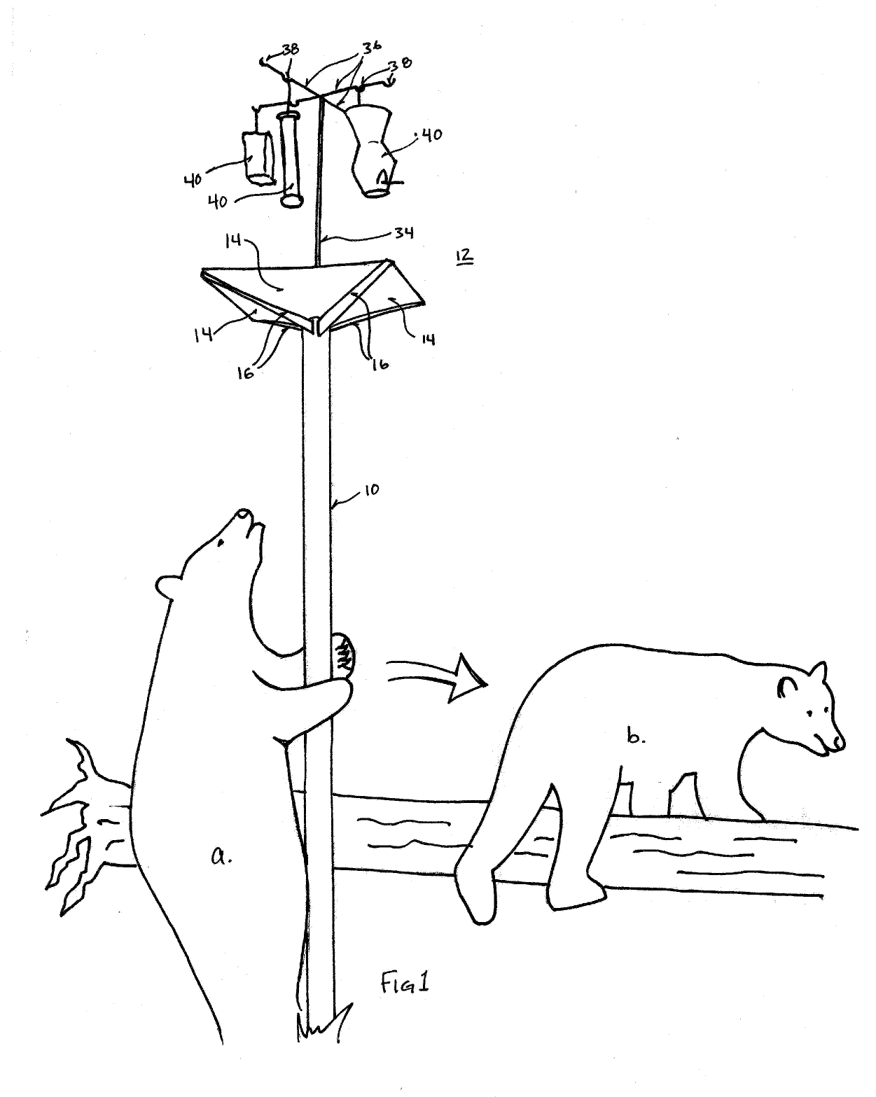

FIG. 1 shows a post (10) having a basin (12) being held generally out of the reach of a bear (a). The post (10) is best anchored securely into the ground, but need be reinforced only to the point of moderate pushing and pulling by the bear (a). In this embodiment, which is preferred, the basin (12) further comprises at least one catch face (14) being sized and oriented so as to catch bird food (40), comprising; suet, seeds, grains, fruits and the like. In this embodiment at least one arm (16) is arranged so as to support the catch face (14). A central column (34) is arranged to further extend the food (40) for the birds. By the observation of this inventor, when the bear (a) approaches the basin (12) it will sniff and explore in the vicinity, and finding no food source, the bear (b) will quickly lose interest and move on. It therefore becomes a no reward system for the bear or other animal.

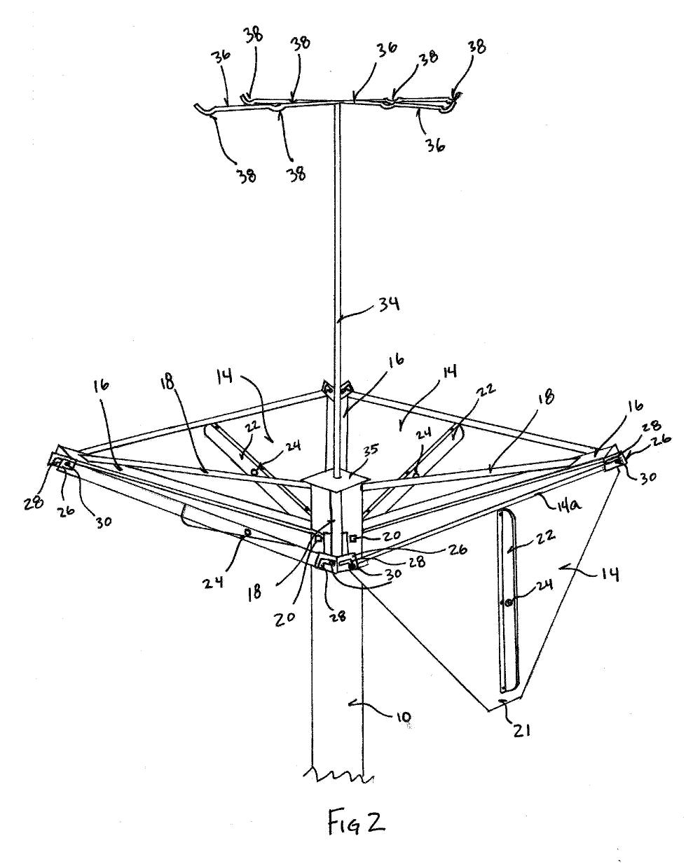

Those seeking to make and use such a system are directed to FIG. 2 showing and least one means for making and using such a system. The post (10) is shown having a plurality of arms (16) with a form of tensor (18), which in this case is a secondary bar welded between the post (10) and the end of arm (16). The tensor is connected at a predetermined location on the arm (16) and the post (10) to increase the load bearing capability of the catch face (12). The arms (16) are generally comprised of a rigid material such as steel or the like, with the tensor being of material suited to tensile stresses, such as steel or cable. This particular embodiment deploys 4 tensors (18) and arms (16), however those skilled in the art will recognize that this number may vary according to requirements of the system and wishes of the artisan.

A catch face (14) is positioned between each of the arms (16) and is designed to generally fill the void between the arms (16). In a preferred embodiment sheets of a Plexiglas type material Lexan® are used, however acrylic or other such stiff sheet materials or a taut cloth with a reinforced perimeter can be deployed. A stiffener (22) can also be added in predetermined positions to lessen warping over time. In this embodiment, a latch hole (24) is included for use as will be discussed at a later time. In this embodiment, the perimeter of the catch face (14) is doubled over, or bent, in order to form a perimeter end (14a) which further stiffens the catch face (14).

A cleat (20) which can be a ledge, shelf, ridge, outcrop, protuberance, or the like, and is formed at a predetermined location on the post (10), such that the catch end (21) of the catch face (14) can come to rest on the post to form a latched position and be removed, disconnected, disengaged or detached to swing freely as is shown on the fore right face (14) of FIG. 1.

A central column (34) can be positioned extending in a general upward direction from a plate (35) at the top of the post (10). The central column (34) is provided for convenience in hanging various forms of a food source (40) from feeder holders (36) which can have notches (38) or depressions for better securing the food (40).

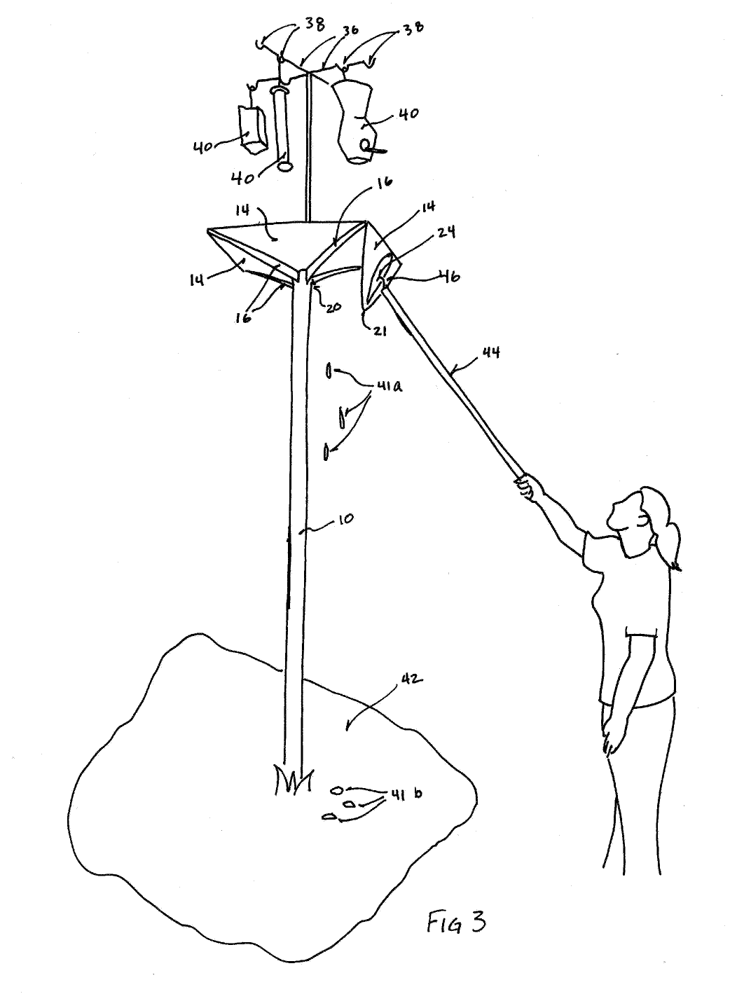

As shown in FIG. 3; cleaning or servicing may be accomplished by an individual spreading a covering (42) such as a tarp, ground cloth, canvas, cover, or sheet on the ground in the general vicinity below the basin (12). The individual can then use a pole (44) shaft, stick, or post having a hook to move the catch face from a catch position to a release position. This can be done by inserting the hook into the latch hole (24) and move the catch face (14) such that is releases any seed or waste (41a) which falls to and collects (41b) on the covering (42). Upon completion of the cleaning, the covering (42) is then removed and taken away such that substantially none of the seeds (41b) remain in the vicinity.

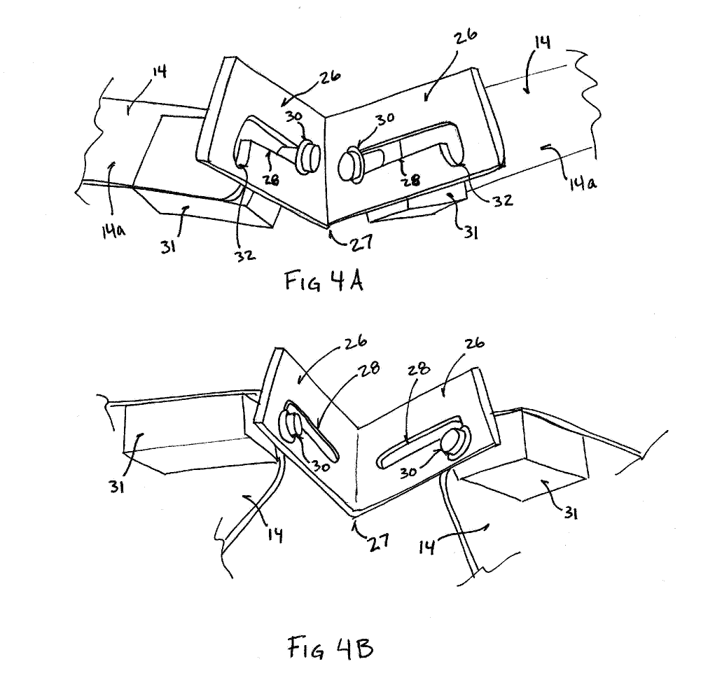

FIGS. 4A and 4B shows more detail regarding a mechanism for moving the catch face (14) between the catch and the release positions. A series of plates (26) can be attached at or near the distal end of the arms (16) as shown in FIG. 2. In this instance, two plates (26) are conjoined at a base (27) at substantially a 90 degree angle at approximately the attach point of between the base (27) and an arm (16) (not shown). A race or a slot (28) is provided to allow movement of the catch face (14) which is securely joined at or near the perimeter end (14a) to a block (31). A guide member (30) such as a pin, a nail, stick, pin, spike, peg, or a tack, generally having a head, is joined to the block (31) and situated through the slot (28). In a catch position, the guide (30) is moved forward such as is shown in FIG. 4A, such that the catch end (21) (not shown in this Figure) is seated on the cleat (20) to form a catch position.

As desired, when the catch face (14) is moved into the release position, as illustrated in FIG. 3, the guide (30) slides distally along the slot (28) coming to rest in a notch (32) which is generally lower than the slot (28) so as not to slide back into position before the desired time.

### CONCLUSION, RAMIFICATIONS, AND SCOPE

Although the present invention has been described in detail, those skilled in the art will understand that various changes, substitutions, and alterations herein may be made without departing from the spirit and scope of the invention in its broadest form. The invention is not considered limited to the example chosen for purposes of disclosure, and covers all changes and modifications which do not constitute departures from the true spirit and scope of this invention.

For example, although the foregoing refers to aviary and non aviary animals, it is contemplated that the no reward method can apply to other situations where a particular animal may lose interest in a potential food source when denied access. Further, details may vary from embodiment to embodiment in terms of dimensions and exact position of structural members, depending on the physical arrangement of the structural members.

Having thus described the invention, what is desired to be protected by Letters Patent is presented in the subsequent appended claims.

We claim:

1. A method for deploying a feeder which provides no reward to a non aviary animal comprising:
(i) providing a feeding device, having feed suited to an aviary animal, above the ground and out of the reach of the non aviary animal;
(ii) providing a catching device below the feeding device
(iii) the catching device being sufficient to catch substantially all feed discarded by the aviary animal as it feeds.

2. A method for deploying a feeder which provides no reward to a non aviary animal in accordance with claim 1 wherein the feeding device is adapted to birds.

3. A method for deploying a feeder which provides no reward to a non aviary animal in accordance with claim 2 further comprising a multiple of feeding devices having a common catching device.

4. A method for deploying a feeder which provides no reward to a non aviary animal in accordance with claim 2 wherein the catching device is comprised of taut cloth.

5. A method for deploying a feeder which provides no reward to a non aviary animal in accordance with claim 2 wherein the catching device comprises at least one tray

6. A method for deploying a feeder which provides no reward to a non aviary animal in accordance with claim 5 wherein at least one tray is Plexiglas® like material.

7. A method for deploying a feeder which provides no reward to a non aviary animal in accordance with claim 5 wherein the height of the at least one tray is above the ground sufficient to be out of the reach of a bear.

8. A method for deploying a feeder which provides no reward to a non aviary animal in accordance with claim 7 wherein the means of holding the feeding device and the catching device comprises a sturdy post.

9. A method for deploying a feeder which provides no reward to a non aviary animal in accordance with claim 8 wherein cleaning of the catching device is accomplished by a person standing at ground level.

10. A method for deploying a feeder which provides no reward to a non aviary animal in accordance with claim 9 wherein the contents of the catching device is emptied onto a tarp on the ground.

11. A method for deploying a bird feeder which provides no reward to a bear comprising:
(i) providing a sturdy post affixed to the ground and of sufficient height that the top thereof is beyond the bear's reach;
(ii) providing a tray affixed to the post, sufficient to catch seeds or like content discarded by birds;
(iii) providing a means for hanging at least one bird feeding device above the tray.

12. A method for deploying a bird feeder which provides no reward to a bear according to claim 11 further comprising the means for hanging the at least one bird feeding device comprises at least one hook.

13. A method for deploying a bird feeder which provides no reward to a bear according to claim 12 further comprising multiple hooks and multiple feeding devices having a variety of bird foods.

14. A method for deploying a bird feeder which provides no reward to a bear according to claim 12 wherein the tray comprises a multiple of panels being rotationally attached on a perimeter edge of a holding structure.

15. A method for deploying a bird feeder which provides no reward to a bear according to claim 14 wherein cleaning of the tray is accomplished by a person standing at the ground level being able to manipulated said panels.

16. A method for deploying a bird feeder which provides no reward to a bear according to claim 15 wherein the contents of the tray is emptied onto a tarp on the ground.

17. A method for deploying a bird feeder which provides no reward to a bear according to claim 16 wherein the tarp is removed to a separate area from the bird feeder before emptying the contents thereof.
